(19) United States
(12) Patent Application Publication
(10) Pub. No.: US 2006/0155657 A1
(43) Pub. Date: Jul. 13, 2006

(54) Apparatus and method for generating a fee label for a mailing item

(75) Inventors: Rolf Schneeberger, Bern (CH); Martin Buser, Zurich (CH); Marcel Schibli, Pfaffikon (CH)

Correspondence Address: HARNESS, DICKEY & PIERCE, P.L.C., P.O. BOX 828, BLOOMFIELD HILLS, MI, 48303, US

(73) Assignee: Die Schweizerische Post, Bern (CH)

(21) Appl. No.: 11/301,752

(22) Filed: Dec. 13, 2005

(30) Foreign Application Priority Data
Dec. 15, 2004 (CH) CH-2076/04

(51) Int. Cl. G06F 17/00

(52) U.S. Cl. 705/404

(57) ABSTRACT

The apparatus has a weight sensor for determining the weight of a mailing item, as well as a measuring device for measuring the size of the same. A processing device determines an appropriate fee depending on the weight and size and, where applicable, other parameters, such as destination and type of shipping. The apparatus then generates a fee label indicative of the determined fee, e.g. in a machine readable code. The measuring device for measuring the size of the mailing item is formed by markings applied to walls perpendicular to the weighing table. The fee labels advantageously carry two machine readable encodings, one of which can be read by a cash register, while the other can be read in a shipping plant.

### CROSS REFERENCE TO RELATED APPLICATIONS

This application claims the priority of Swiss patent application 2076/04, filed 15 Dec. 2004, the disclosure of which is incorporated herein by reference in its entirety.

### BACKGROUND OF THE INVENTION

The invention relates to an apparatus for generating a fee label for a mailing item, and to a system and method for shipping such mailing items.

For properly calculating the shipping fee of mailing items, such as parcels and letters, their weight and size has to be determined. Depending on these parameters and on a type of shipping (such as “overnight”, “priority”, “regular”) and a destination region, the suitable tariff or fee can be derived.

### BRIEF SUMMARY OF THE INVENTION

It is a general object of the invention to provide an apparatus, system and method of the type above that simplifies this procedure.

Now, in order to implement these and still further objects of the invention, which will become more readily apparent as the description proceeds, the apparatus according to the present invention comprises

a weight detector for measuring a weight of a mailing item,

a measuring device for determining at least one dimension of the mailing item,

a processing device for determining a suitable tariff depending on the weight and the at least one dimension, and

a label generator for issuing a label indicating the tariff.

A second aspect of the invention relates to a system for labelling and expediting of mailing items comprising such an apparatus and further comprising

at least one cash register for the payment of a tariff for the fee label and

a shipping plant for partially or fully automated dispatching of the mailing items.

A third aspect of the invention relates to a method for mailing a mailing item comprising the steps of

measuring a weight of said mailing item in an apparatus,

determining at least one dimension of said mailing item by means of said apparatus,

operating said apparatus to determine a suitable tariff depending on the weight and the at least one dimension and to issue a label for said mailing item indicating the tariff, wherein said apparatus prints a first and a second machine readable code on said label,

reading the first machine readable code by means of a cash register to determine a tariff to be paid therefrom,

dispatching said mailing item by means of a shipping plant wherein said second machine readable code is read by said shipping plant.

Hence, the apparatus is equipped with a weight detector for determining the weight of the mailing item as well as with a measuring device for determining at least one dimension of the mailing item. Further, it comprises a processing device for determining a suitable mailing tariff (i.e. mailing price) depending on the weight and the at least one dimension of the mailing item and, where applicable, on other parameters, such as the destination and type of shipping. Finally, it comprises a label generator for issuing a label indicating the tariff determined in this manner, e.g. encoded by means of a machine readable code printed on the label.

The apparatus can e.g. comprise a height measuring device arranged on a vertical wall at the weighing table of the weight detector. The height measuring device allows to attribute the mailing item on the weighing table to one of at least two different height classes. Hence, not only the weight, but also of the height or height class of the item on the weighing table can be determined easily.

The weight detector should be rugged but accurate and it should be able to measure large as well as small mailing items. Therefore, it is advantageously equipped with a tilt sensor. The tilt sensor is located at an edge region of the weighing table for detecting an incorrectly placed load on said weighing table. An incorrectly placed load can e.g. consist of a small, heavy item that has been placed too close to the edge of the weighing table.

The apparatus can be part of a system for labelling and expediting of mailing items, which system further comprises at least one cash register where the fee for the label is paid. The system further comprises a shipping plant for partially or fully automated dispatching the mailing items.

Advantageously, the processing device of said apparatus is able to print fee labels that have a first machine readable code for the cash register and a second, separate machine readable code for the shipping plant. The cash register then reads the first machine readable code and determines the fee to be paid therefrom. The second machine readable code allows the shipping plant to determine the desired shipping class and/or to verify the authenticity of the fee label. Since two separate machine readable codes are provided, there is no need for the cash register and the shipping plant to fulfil a common standard, which allows an easily implementation of the invention in existing systems.

Advantageously, the first machine readable code is an EAN code, in particular an EAN-13 barcode. These code types can be read by conventional cash registers, e.g. at a retailer, and be converted to pricing information. This allows to use the invention with conventional cash registers as they are used by retailers.

An EAN code is understood to be a code according to the EAN standard, as administered by the organisation EAN International, Brussels.

It must be noted that the term “mailing item” is defined to designate a physical mailing item, such as a parcel or a letter, but not an electronic mailing item, such as an e-mail.

The term “label” is also defined to designate a physical label, in particular sticker, to be applied to the mailing item.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows an embodiment of an apparatus according to the present invention,

FIG. 2 is a sectional view of the weight detector unit,

FIG. 3 is a system for labelling and expediting mailing items, and

FIG. 4 shows a fee label.

### DETAILED DESCRIPTION OF THE INVENTION

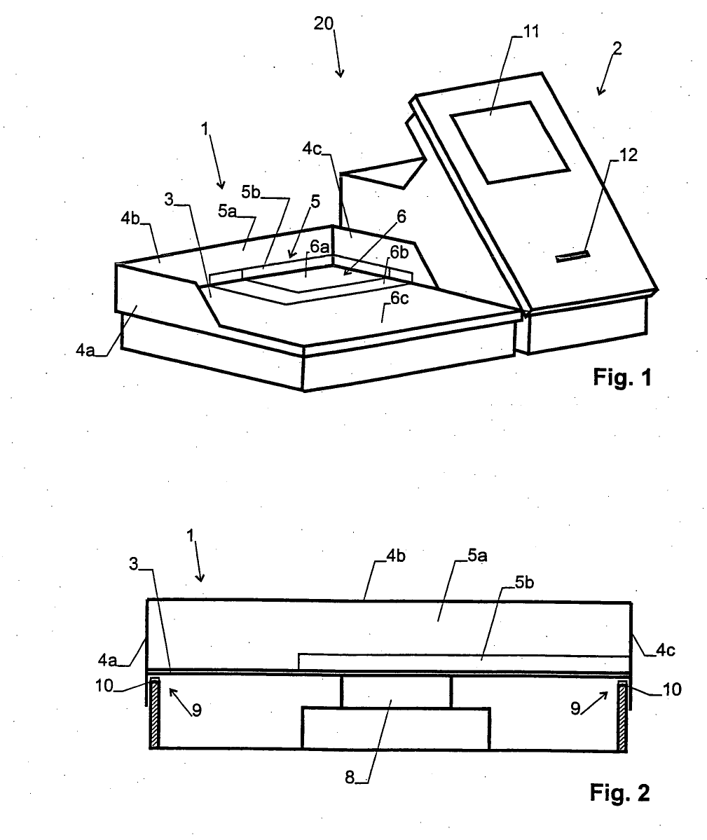

An advantageous embodiment of the apparatus according to the present invention is shown in FIG. 1. It consist of a weight detector unit 1 and a control unit 2.

Weight detector unit 1 is used for determining the weight of a mailing item. It comprises a horizontal weighing table 3 for receiving the mailing item. Three vertical walls 4a, 4b, 4c are arranged at the edge of weighing table 3 and perpendicular thereto. A first wall extends along a rear half of a first side edge of weighing table 3, a second wall 4b is perpendicular to first wall 4a and extends along the rear edge of weighing table 3. A third wall 4c is perpendicular to second wall 4b and extends along the rear half of the second lateral edge of weighing table 3. Advantageously, the walls 4a, 4b, 4c are mounted to the weighing table, which has the advantage to allow accurate measurements even if the mailing item is in contact with one of the walls.

A height measuring device 5 is arranged on the vertical walls, in the present case on the walls 4b and 4c. It allows to attribute the mailing item on weighing table 3 to one of several height classes.

In the present embodiment height measuring device 5 is formed by a height scale comprising one or more scale entries, e.g. in the form of horizontal, differently colored stripes 5a, 5b. Each stripe extends over one height class. The stripe that is at the height of the top edge of the mailing item defines the height class of the same.

In addition to this, a width and depth measuring device 6 is arranged on weighing table 3. It allows to attribute a mailing item that lies on the table in contact with the walls 4b, 4c to one of at least two size classes.

In the present embodiment, the width and depth measuring device 6 is formed by three differently colored regions 6a, 6b, 6c. The smallest colored region that encloses the mailing item defines the size class of the same.

Weight detector unit 1 comprises a weight detector for measuring the weight of the mailing item. As seen from FIG. 2, a weight sensor 8 of the weight detector is arranged below weighing table 3. Weight sensor 8 supports the center of weighing table 3. Since weight sensor 8 is substantially smaller than weighing table 3, it can happen that a comparatively small but heavy mailing item leads to an intolerable tilt momentum if its is deposited in an edge region of weighing table 3. Therefore, one or more tilt sensors 9 are provided in the edge regions. The tilt sensors 9 are able to detect an erroneously placed load such that the users can, if necessary, be requested to center the mailing item on the weighing table.

Advantageously, each tilt sensor 9 is arranged below an edge region of weighing table 3 and designed such that it is activated by an approach of weighing table 3. For example, microswitches can be used. In a particularly simple embodiment, each tilt sensor can consist of a simple electric contact 10, which contacts weighing table 3 when the same is titled excessively. A current flowing through electric contact 10 and weighing table 3 can then be detected.

In the embodiment of FIGS. 1 and 2, where the weight sensor 8 is in the center below rectangular weighting table 3, four tilt sensors 9 are provided, one below each corner region of weighing table 3.

The tilt sensors 9 are actuated only by very heavy, small items. When the tilt sensors 9 are not actuated, the weight detector is able to measure the weight of the mailing item, even if the same is in contact with the walls 5b, 5c, which allows the weight and height to be measured in one step.

A processing device, as described in the following, is arranged in control unit 2. The purpose of the processing device is to determine an appropriate fee depending on the weight and the size of the mailing item. The fee may also depend on other parameters, such as the mailing type and the target address or region.

For this purpose en electronic interface is provided between the weight detector and the processing device, which allows the processing device to automatically obtain the weight of the mailing item from the weight detector.

In addition to this, the processing device comprises input means, e.g. in the form of a touch sensitive screen 11, that allow a user to manually enter the height class, a width class and a depth class that he determined by means of height measuring device 5 and size measuring device 6. For example, the processing device offers a choice of several size classes. Mailing items that fall into the smallest height class, width class and depth class are attributed to the smallest size class. Mailing items that fall, in at least one dimension, into the next higher class, are attributed to a medium size class, etc.

As soon as the processing device determines the fee for the mailing item, it operates a label generator, e.g. a printer with output slit 12, and generates a fee label that is to be attached to the postal item.

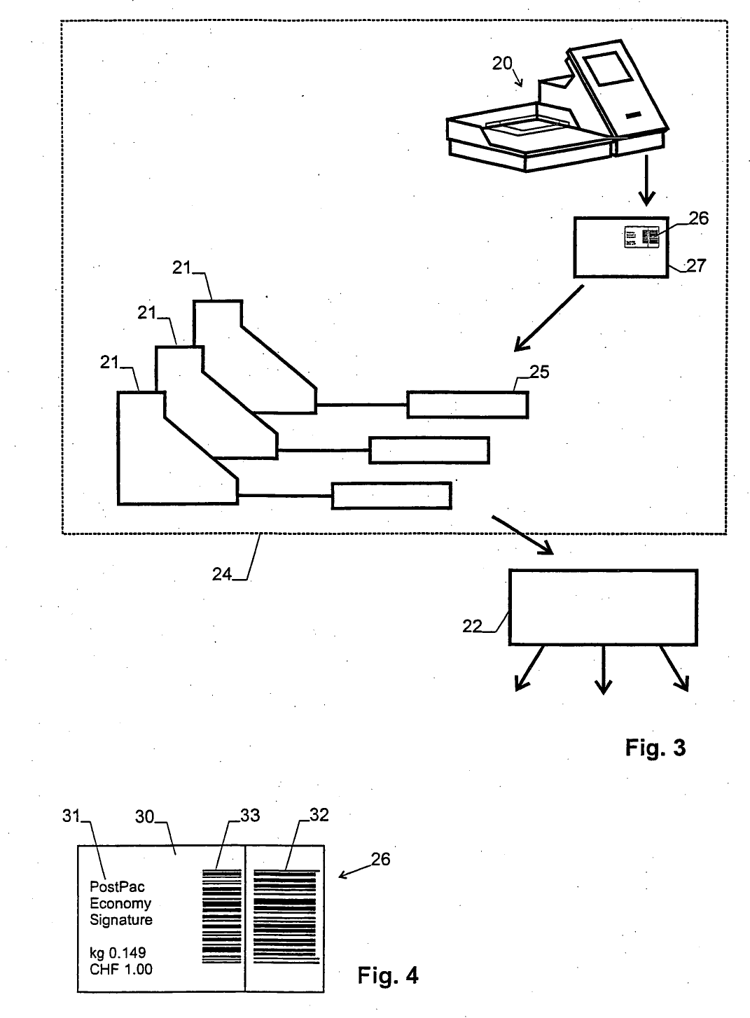

The apparatus shown here is advantageously used in a system as shown in FIG. 3.

This system comprises one or more apparatuses 20 of the described type, one or more cash registers 21 for paying a tariff corresponding to the fee, and at least one shipping plant 22 for a partially or fully automated dispatching of the mailing items.

The cash registers 21 are, together with an apparatus 20, e.g. located in a department store of a retailer 24. The cash registers 21 are provided with barcode readers 25, by means of which the fee labels 26 can be read. From the read information, the cash registers determine the tariff to be paid. The cash registers 21 are, however, also able to read EAN codes, in particular EAN-13 barcodes, on other articles that are sold by the retailer.

The mailing items 27 are transferred to the employees at the cash registers 21, and then dispatched to the postal service operating the shipping plant 22, wherein the term “postal service” encompasses traditional postal services as well as other courier services of any type. Shipping plant 22 can e.g. be a plant for automatically sorting of mailing items. Shipping plant 22 is also able to read the fee labels 26 automatically, e.g. for determining the type of shipping, for item tracking, or for checking the authenticity of the fee labels.

To make automatic communication of the individual parts of the system of FIG. 3 easy, fee label 26 is advantageously of the type as generally shown in FIG. 4.

Fee label 26 of FIG. 4 comprises an adhesive carrier 30, upon which apparatus 20 can print three partially redundant markings 31, 32 and 33.

A first marking 31 describes the information on the fee label in human readable form. In particular, the type of shipping (e.g. “economy”, signature”, “priority” or “first class mail”) is displayed, as well as the weight, the size (e.g. “small parcel” or “letter”) and the price of the label. A second marking 32 comprises substantially the same data, but encoded as a first machine readable code, advantageously as an EAN-13 barcode. The third marking 33 also comprises substantially the same data, but encoded in a second machine readable code, e.g. in a bar code or dot code. The second machine readable code is, as seen in FIG. 4, advantageously separate (i.e. located at a distance of) the first machine readable code.

The encoding used in the first and second machine readable code is advantageously different. The first machine readable code in marking 32 is designed to be read by the cash registers. Advantageously, it uses the same format as retailers use for weight-variable or price-variable merchandise, such as fruits weighed by the customer. The encoding comprises a price value that can be read by cash register 21.

The second machine readable code is, on the other hand, in an encoding that corresponds to the standards used in shipping plant 22, such that it can be read by the same without modifications.

For shipping a mailing item by means of the system of FIG. 3, a user goes to the premises of retailer 24 and places mailing item 27 on the weighing table of one of the apparatuses 20. It should advantageously be in contact with the walls 4b and 4c. Weight detector unit 1 then automatically determines the weight of the item. In addition, apparatus 20 asks the user for the size class, which he can, as described above, determine by means of the height measuring device 5, and the width and depth measuring device 6. Further, apparatus 20 asks for the desired type of shipping as well as for the geographical destination area, such as a country or a specific address. From these data, apparatus 20 determines the appropriate fee and prints a fee label 26. The user attaches fee label 26 to mailing item 27 and takes the same to one of the cash registers 21. There the fee label 26 is read by means of barcode reader 25 and cash register 21 determines the amount to be paid. At the same time, the user can pay other products purchased from the retailer. After payment, the mailing item is received by the retailer's employee at the cash register and put into intermediate storage. The postal service collects the mailing items 27 at the retailer's site in regular intervals or upon request, and takes them for further processing to shipping plant 22, where they are sorted and then forwarded to suitable further channels of distribution.

As follows form the above, apparatus 20 fits seamlessly into existing infrastructure. It is robust and easy to use and it allows to make postal services accessible to the public in a simple manner.

The apparatus 20 as shown is only one of several possible embodiments of the invention. For example, the size of the mailing item can also be determined in automatic or semi-automatic manner instead of manually. For example, the height measuring device can also be formed by a light barrier, which is arranged at a given height, e.g. between the walls 4a, and 4c. Other optical means of measurement, e.g. a camera with image processing circuitry, can be used for determining the height of the mailing item.

While there are shown and described presently preferred embodiments of the invention, it is to be distinctly understood that the invention is not limited thereto but may be otherwise variously embodied and practised within the scope of the following claims.

1. An apparatus for generating a fee label for mailing items comprising
a weight detector for measuring a weight of a mailing item,
a measuring device for determining at least one dimension of the mailing item,
a processing device for determining a suitable tariff depending on the weight and the at least one dimension, and
a label generator for issuing a label indicating the tariff.

2. The apparatus of claim 1 wherein the weight detector comprises a weighing table and wherein the apparatus comprises at least one vertical wall, the vertical wall comprising a height measuring device for attributing the mailing item lying on the weighing table to one of at least two height classes.

3. The apparatus of claim 2 wherein the height measuring device comprises a height scale with at least one scale entry on the wall.

4. The apparatus of claim 3 wherein said height scale is formed by differently colored horizontal stripes on said wall.

5. The apparatus of claim 2 comprising at least two mutually perpendicular vertical walls.

6. The apparatus of claim 2 comprising at least three mutually perpendicular vertical walls.

7. The apparatus of claim 2 wherein said at least one vertical wall is mounted to said weighing table.

8. The apparatus of claim 2 further comprising a height and width measuring device for attributing the mailing item lying on said weighing table in contact with said wall to one of at least two size classes.

9. The apparatus of claim 2 wherein the processing device comprises input means for manually entering at least the height class of the mailing item, wherein the processing device is adapted to determine said tariff in dependence of said height class.

10. The apparatus of claim 1 further comprising an electronic interface between said weight detector and said processing device, wherein said processing device is adapted to retrieve the weight of said mailing item from said weight detector through said interface.

11. The apparatus of claim 1 further comprising
a weighing table,
a weight sensor arranged below said weighing table, and
a tilt sensor arranged at an edge region of the weighing table for detecting an incorrectly placed load on said weighing table.

12. The apparatus of claim 11 wherein the tilt sensor is adapted to be triggered if the weighing table approaches said tilt sensor.

13. The apparatus of claim 12 wherein the tilt sensor comprises a contact that to be contacted by said weighing table.

14. The apparatus of claim 11 wherein the weight sensor is arranged below a center of the weighing table and tilt sensors are arranged below corner regions of said weighing table.

15. A system for labelling and expediting mailing items comprising an apparatus of claim 1 and further comprising
at least one cash register for the payment of a tariff for the fee label and
a shipping plant for partially or fully automated dispatching of the mailing items.

16. The system of claim 15 wherein
said processing device is adapted to print fee labels that comprise a first machine readable code for the cash register and a second machine readable code for the shipping plant,
said cash register is adapted to read the first machine readable code and to determine a tariff to be paid therefrom, and
said shipping plant is adapted to read the second machine readable code.

17. The system of claim 16 wherein said shipping plant is adapted to determine a shipping type and/or to check an authenticity of the label from said second machine readable code.

18. The system of claim 16 wherein the first machine readable code is an EAN code, in particular an EAN-13 barcode.

19. A method for mailing a mailing item comprising the steps of
measuring a weight of said mailing item in an apparatus,
determining at least one dimension of said mailing item by means of said apparatus,
operating said apparatus to determine a suitable tariff depending on the weight and the at least one dimension and to issue a label for said mailing item indicating the tariff, wherein said apparatus prints a first and a second machine readable code on said label,
reading the first machine readable code by means of a cash register to determine a tariff to be paid therefrom,
shipping said mailing item by means of a shipping plant wherein said second machine readable code is read by said shipping plant.
